(19) United States
(12) Patent Application Publication
(10) Pub. No.: US 2026/0247089 A1
(43) Pub. Date: Aug. 20, 2026

(54) AUDIO DETECTION METHOD AND AUDIO DETECTION DEVICE

(71) Applicant: REALTEK SEMICONDUCTOR CORPORATION, HSINCHU (TW)

(72) Inventor: YING-YING CHAO, HSINCHU (TW)

(21) Appl. No.: 19/535,445

(22) Filed: Feb. 10, 2026

(30) Foreign Application Priority Data
Feb. 17, 2025 (TW) 114105815

(51) Int. Cl. H04R 29/00; G10L 25/51

(52) U.S. Cl. CPC H04R 29/004; G10L 25/51

(57) ABSTRACT

An audio detection method executed by a processor reading at least command stored in a memory includes: performing a framing process on audio to generate audio frames; dividing the audio into audio segments according to signal intensities of the audio frames; calculating actual pitches of a target audio segment of the audio segments; calculating predicted pitches according to the actual pitches; calculating pitch differences according to the actual pitches and the predicted pitches; calculating a threshold exceedance count according to the pitch differences and a pitch threshold; if the threshold exceedance count is larger than a portion of a total number of pitches of the actual pitches of the target audio segment, determining that the target audio segment is a plurality of sound-source audio segment; and if the threshold exceedance count is zero, determining that the target audio segment is a single sound-source audio segment.

### BACKGROUND OF THE INVENTION

### 1. Field of the Invention

The present disclosure relates to an audio detection method and an audio detection device, especially to an audio detection method and an audio detection device configured to detect audio to obtain a number of sound-sources.

### 2. Description of Related Art

When an accident occurs, elderly people and school-age children require more assistance. If an electronic device can be used to perform accident detection and notify an emergency contact of an accident detection result, it will help the emergency contact promptly understand the accident situation, thereby facilitating the emergency contact to perform corresponding processing.

However, existing detection approaches usually adopt image-tracking technologies, which require additional installation of cameras. In addition, when encountering accident situations such as falling or fainting, it is relatively difficult to monitor the actual accident situations of elderly people and school-age children by using the image-tracking technologies.

### SUMMARY OF THE INVENTION

In some aspects, an object of the present disclosure is to, but not limited to, provide an audio detection method and an audio detection device that make an improvement to the prior art.

In some embodiments, the present disclosure provides an audio detection method, executed by a processor reading at least one command stored in a memory. The audio detection method includes: performing a framing process on audio to generate a plurality of audio frames; dividing the audio into a plurality of audio segments according to a plurality of signal intensities of the plurality of audio frames; calculating a plurality of actual pitches of the plurality of audio frames of a target audio segment of the plurality of audio segments; calculating a plurality of predicted pitches according to the plurality of actual pitches of the target audio segment; calculating a plurality of pitch differences according to the plurality of actual pitches of the target audio segment and the plurality of predicted pitches; calculating a threshold exceedance count according to the plurality of pitch differences of the target audio segment and a pitch threshold; if the threshold exceedance count is larger than a portion of a total number of pitches of the plurality of actual pitches of the target audio segment, determining that the target audio segment is a plurality of sound-source audio segment; and if the threshold exceedance count is zero, determining that the target audio segment is a single sound-source audio segment.

In some embodiments, an audio detection device includes a memory and a processor. The memory is configured to store at least one command. The processor is configured to read the at least one command in the memory to execute: performing a framing process on audio to generate a plurality of audio frames; dividing the audio into a plurality of audio segments according to a plurality of signal intensities of the plurality of audio frames; calculating a plurality of actual pitches of the plurality of audio frames of a target audio segment of the plurality of audio segments; calculating a plurality of predicted pitches according to the plurality of actual pitches of the target audio segment; calculating a plurality of pitch differences according to the plurality of actual pitches of the target audio segment and the plurality of predicted pitches; calculating a threshold exceedance count according to the plurality of pitch differences of the target audio segment and a pitch threshold; if the threshold exceedance count is larger than a portion of a total number of pitches of the plurality of actual pitches of the target audio segment, determining that the target audio segment is a plurality of sound-source audio segment; and if the threshold exceedance count is zero, determining that the target audio segment is a single sound-source audio segment.

Technical features of some embodiments of the present disclosure make an improvement to the prior art. The audio detection method and the audio detection device of the present disclosure may be applied to various electronic systems, and the number of users can be obtained by collecting audio through the electronic system and performing calculation on the audio, not only avoiding the problem that using the image-tracking technologies has blind spots and cannot effectively monitor users, but also having advantages of low computational load and ease of implementation.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of an audio detection device of the present disclosure.

FIG. 2 shows an embodiment of a flow diagram of an audio detection method of the present disclosure.

FIG. 3 shows an embodiment of audio and an audio frame of the present disclosure.

FIG. 4 shows an embodiment of audio and pitch of the present disclosure.

FIG. 5 shows an embodiment of audio and pitch of the present disclosure.

FIG. 6 shows an embodiment of a flow diagram of an audio detection method of the present disclosure.

FIG. 7 shows an embodiment of audio and pitch of the present disclosure.

FIG. 8 shows an embodiment of audio and pitch of the present disclosure.

FIG. 9 shows an embodiment of audio and pitch of the present disclosure.

### DETAILED DESCRIPTION OF THE PREFERRED EMBODIMENTS

To avoid the problem that an image tracking technology has blind spots and thus cannot effectively monitor a user, the present disclosure provides an audio detection method and an audio detection device, and detailed descriptions are given below.

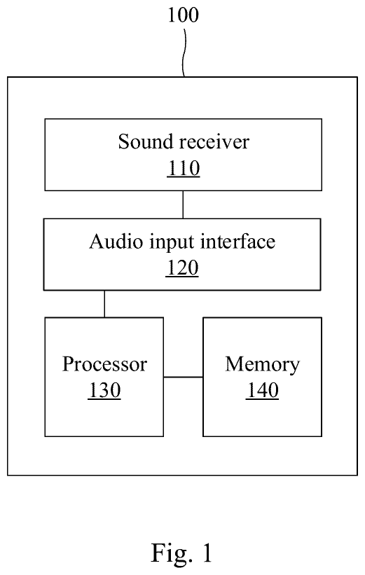

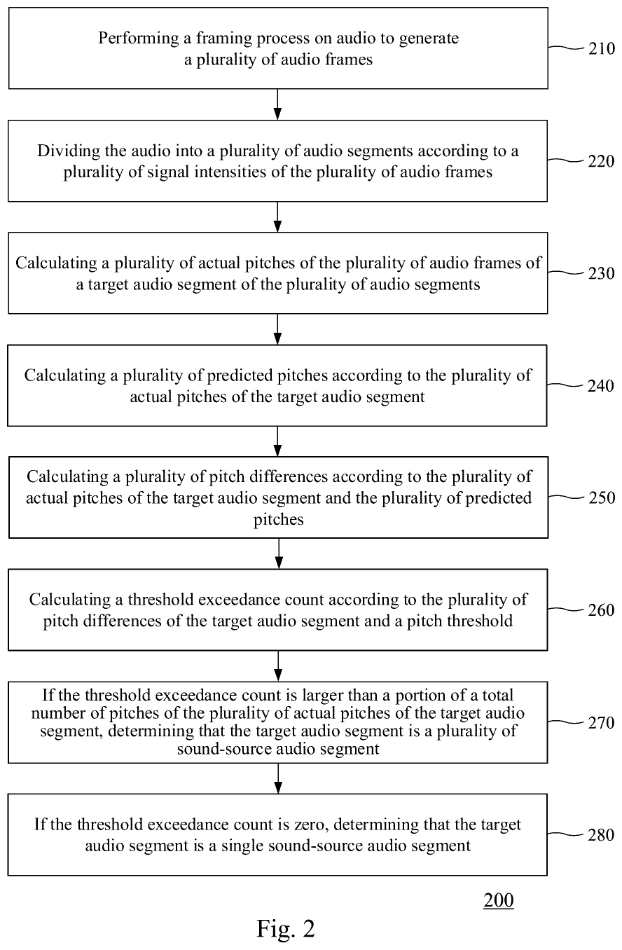

FIG. 1 shows an embodiment of an audio detection device 100 of the present disclosure. As shown in the figure, the audio detection device 100 includes a sound receiver 110, an audio input interface 120, a processor 130, and a memory 140. The sound receiver 110 is configured to receive sound and convert the sound into digital audio. Subsequently, the sound receiver 110 inputs the digital audio to the processor 130 through the audio input interface 120. The memory 140 is configured to store at least one command. The processor 130 is configured to read the at least one command to execute an audio detection process. To facilitate understanding of the operation of the audio detection device 100, please also refer to FIG. 2. FIG. 2 shows a flow diagram of an audio detection method 200 according to some embodiments of the present disclosure.

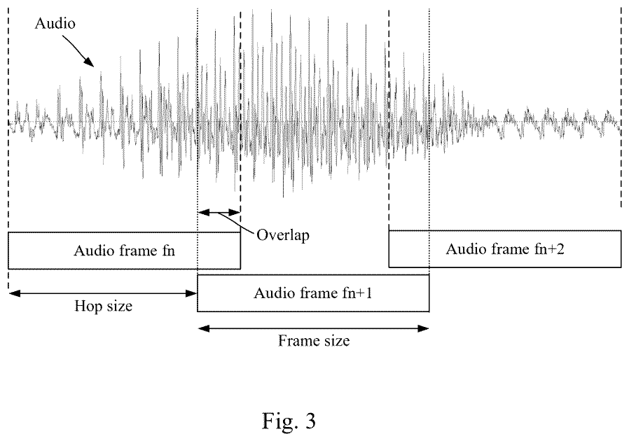

Referring to step 210 in FIG. 2, performing a framing process on audio to generate a plurality of audio frames. For example, referring to FIG. 1 and FIG. 3, the processor 130 of the audio detection device 100 of the present disclosure may perform a framing process on audio to generate a plurality of audio frames fn~fn+2. Specifically, the processor 130 of the audio detection device 100 of the present disclosure may divide the audio into a plurality of overlapping audio frames fn~fn+2, and subsequent acoustic analysis is performed based on the audio frames fn~fn+2.

A sample rate of the processor 130 of the audio detection device 100 of the present disclosure varies according to the audio input interface 120. The sample rate may be 16000 Hz, 24000 Hz, 44100 Hz, or 48000 Hz. In some embodiments, a frame size of an audio frame may be 20 milliseconds (ms). If the sample rate is 48000 Hz, then 960 samples are collected. An overlap ratio between audio frames may be 25%, and an overlap time between audio frames is 5 ms, and 240 samples are overlapped between audio frames. Each audio frame is separated by a hop size. The hop size may be the frame size minus the overlap time; for example, 20 ms minus 5 ms is 15 ms, and the hop size corresponds to 720 samples. However, the present disclosure is not limited to the numerical values given in the above embodiment, and other suitable numerical values may also be adopted depending on actual requirements.

Referring to step 220 in FIG. 2, dividing the audio into a plurality of audio segments according to a plurality of signal intensities of the plurality of audio frames. For example, referring to FIG. 1 and FIG. 3, the processor 130 of the audio detection device 100 of the present disclosure may calculate signal intensities of the audio frames fn~fn+2, where the formula of a signal intensity is shown as follows:

$$E = {\sum }_{i = 1}^{N} {x}_{i}^{2} \qquad Formula 1$$

As shown in Formula 1, E is a signal intensity, xᵢ is a sampling value of an audio frame, and N is a frame size of the audio frame.

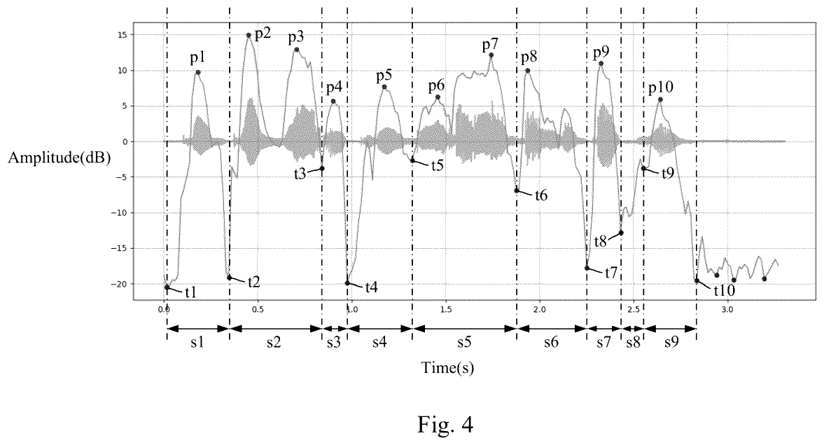

In addition, referring to FIG. 1 and FIG. 4, the processor 130 of the audio detection device 100 of the present disclosure may obtain a plurality of wave crests p1~p10 and a plurality of wave troughs t1~t10 according to the plurality of signal intensities. For example, to obtain a wave crest, the signal intensities of the audio frames must first be calculated, and the signal intensity of an audio frame must be greater than signal intensities of audio frames on both sides, such that an audio frame having the relatively largest signal intensity may be identified as a candidate wave crest. Furthermore, the present disclosure sets thresholds to filter the candidate wave crests, for example, setting a maximum height, a minimum height, and a minimum distance between wave crests. Specifically, the present disclosure may set the minimum height to 1 dB, the maximum height to 25 dB, and the minimum distance between wave crests to 5 hop sizes; if the hop size is 15 ms, then the minimum distance between wave crests is 75 ms. In addition, a method of obtaining a wave trough is similar to the above method of obtaining a wave crest, except that the signal intensities of the audio frames are converted into negative values (multiplied by −1) for relevant calculations. The other calculation steps are the same and thus are not redundantly described herein. The processor 130 of the audio detection device 100 of the present disclosure may obtain wave crest arrays as follows according to the above method:

$$peaks = [ 12 , 30 , 47 , 60 , 78 , 97 , 116 , 129 , 155 , 1 \; 76 ] \qquad Formula 2$$

As shown in Formula 2, “peaks” represents a wave crest, and the number in parentheses indicates an audio frame index. For example, the number “12” in parentheses indicates the 12th audio frame, representing that the 12th audio frame is a wave crest. Likewise, the number “30” in parentheses indicates the 30th audio frame, representing that the 30th audio frame is a wave crest, and so on.

The processor 130 of the audio detection device 100 of the present disclosure may obtain a wave trough array according to the above method as follows:

$$trough = [ 1 , 23 , 56 , 65 , 88 , 125 , 150 , 162 , 170 , 189 , 1 \; 96 ] \qquad Formula 3$$

As shown in Formula 3, “troughs” represents a wave trough, and the number in parentheses indicates an audio frame index. For example, the number “1” in parentheses indicates the 1st audio frame, representing that the 1st audio frame is a wave trough. Likewise, the number “23” in parentheses indicates the 23rd audio frame, representing that the 23rd audio frame is a wave trough, and so on.

Furthermore, the processor 130 of the audio detection device 100 of the present disclosure may divide the audio into a plurality of audio segments s1~s9 according to the plurality of wave troughs t1~t10. For example, the processor 130 of the audio detection device 100 of the present disclosure may divide the audio into an audio segment s1 according to the wave troughs t1, t2, and may divide the audio into an audio segment s2 according to the wave troughs t2, t3, and so on. Specifically, assuming that the wave trough t1 is the first wave trough in the wave trough array of Formula 3, it can be seen from Formula 3 that the wave trough t1 is the 1st audio frame. In addition, assuming that the wave trough t2 is the second wave trough in the wave trough array of Formula 3, it can be seen from Formula 3 that the wave trough t2 is the 23rd audio frame. A calculation formula of the audio segment s1 formed by dividing the audio using the wave troughs t1, t2 is as follows:

$$T 1 = trough ( 1 ) \times hop = 1 \times 15 = 15 ( ms ) \qquad Formula 4$$

$$T 2 = trough ( 2 ) \times hop = 23 \times 15 = 345 ( ms ) \qquad Formula 5$$

As shown in Formulas 4, 5, T1 is a time point of the wave trough t1, and T2 is a time point of the wave trough t2. The term trough(1) is the first wave trough in the wave trough array of Formula 3, and trough(2) is the second wave trough in the wave trough array of Formula 3. The term “hop” represents a hop size. Assuming that trough(1) is the 1st audio frame and the hop size is 15 milliseconds, substituting these values into Formula 4 yields that the time point of the wave trough t1 is 15 milliseconds. Assuming that trough(2) is the 23rd audio frame and the hop size is 15 milliseconds, substituting these values into Formula 5 yields that the time point of the wave trough t2 is 345 milliseconds. Therefore, the audio segment s1, formed by dividing the audio using the wave troughs t1, t2, lies between 15 milliseconds and 345 milliseconds. The processor 130 of the audio detection device 100 of the present disclosure may obtain time intervals of all audio segments s1~s9 according to the above method. However, the present disclosure is not limited to the numerical values given in the above embodiment, and other suitable numerical values may also be adopted depending on actual requirements.

Referring to step 230 in FIG. 2, calculating a plurality of actual pitches of a plurality of audio frames of a target audio segment of the plurality of audio segments. For example, referring to FIG. 1 and FIG. 4, the processor 130 of the audio detection device 100 of the present disclosure may calculate a plurality of actual pitches of a plurality of audio frames of the target audio segment s1 of the plurality of audio segments s1~s9. Specifically, the processor 130 of the audio detection device 100 of the present disclosure may adopt a YIN algorithm to calculate actual pitches of audio frames in the audio segment s1. However, the present disclosure is not limited to the YIN algorithm of the above embodiment, and other suitable algorithms may also be adopted depending on actual requirements.

Referring to step 240 in FIG. 2, calculating a plurality of predicted pitches according to the plurality of actual pitches of the target audio segment. For example, referring to FIG. 1 and FIG. 4, the processor 130 of the audio detection device 100 of the present disclosure may calculate predicted pitches according to actual pitches of audio frames in the target audio segment s1. Specifically, the processor 130 of the audio detection device 100 of the present disclosure may adopt Kalman Filter Tracking to calculate predicted pitches, and a formula of the predicted pitch is as follows:

$${\hat{x}}_{t} = ( 1 - {K}_{t} ) {\hat{x}}_{t - 1} + {K}_{t} {z}_{t} \qquad Formula 6$$

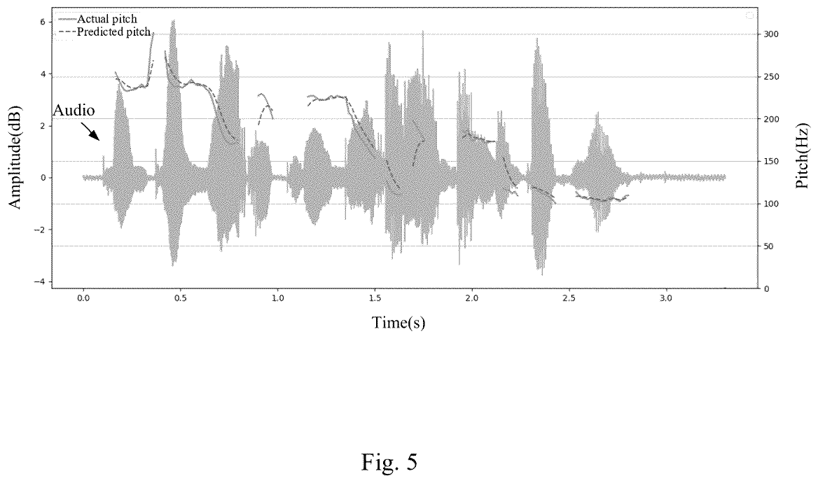

As shown in Formula 6, zₜ is an actual pitch at time t, \hat{x}ₜ is a predicted pitch at time t, \hat{x}ₜ₋₁ is a predicted pitch at time t−1, and Kₜ is a Kalman Gain. According to Formula 6, the present disclosure may calculate predicted pitches according to actual pitches of audio frames in the target audio segment s1. The actual pitches and the calculated predicted pitches are shown in FIG. 5. The solid line indicates actual pitches, and the dashed line indicates predicted pitches calculated by Formula 6. However, the present disclosure is not limited to the Kalman Filter Tracking of the above embodiment, and other suitable algorithms may also be adopted depending on actual requirements.

Referring to step 250 in FIG. 2, calculating a plurality of pitch differences according to a plurality of actual pitches of the target audio segment and a plurality of predicted pitches. For example, referring to FIG. 1 and FIG. 5, the processor 130 of the audio detection device 100 of the present disclosure may calculate pitch differences according to actual pitches (solid line) of the target audio segment and predicted pitches (dashed line). A formula of the pitch difference is as follows:

$${diff}_{i} = {fr}_{i} ( {P}_{true} ) - {fr}_{i} ( {P}_{track} ) \qquad Formula 7$$

As shown in Formula 7, diffᵢ is a pitch difference, frᵢ(Pₜᵣᵤₑ) is an actual pitch, and frᵢ(P_{track}) is a predicted pitch. Referring to FIG. 5, if the actual pitch and predicted pitch are close to each other, it represents a single sound-source (e.g., only one person speaking). In this case, actual pitches are close to predicted pitches, and the pitch differences are small. On the contrary, if the actual pitch and the predicted pitch are relatively far apart, it represents that the current state is not a single sound-source, which results in an inaccurate prediction. In this condition, the current state should be a plurality of sound-sources (e.g., multiple persons are speaking). In this condition, the actual pitch deviates from the predicted pitch, and the pitch difference is relatively large.

Referring to step 260 in FIG. 2, calculating a threshold exceedance count according to a plurality of pitch differences of the target audio segment and a pitch threshold. For example, referring to FIG. 1, the processor 130 of the audio detection device 100 of the present disclosure may calculate a threshold exceedance count according to pitch differences of the target audio segment and a pitch threshold. A formula of the threshold exceedance count is as follows:

$$S = {\sum }_{i = n}^{n + m} 1 ( \vert {diff}_{i} \vert > {diff}_{thd} ) \qquad Formula 8$$

As shown in Formula 8, S is a threshold exceedance count, diffᵢ is a pitch difference, diff_{thd} is a pitch threshold, and the term “1(·)” in Formula 8 represents an indicator function which equals 1 when the condition in parentheses is true and equals 0 otherwise.

Referring to step 270 in FIG. 2, if the threshold exceedance count is larger than a portion of a total number of pitches of the plurality of actual pitches of the target audio segment, the target audio segment is a plurality of sound-source audio segment. For example, referring to FIG. 1 and FIG. 4, the processor 130 of the audio detection device 100 of the present disclosure may adopt the YIN algorithm to calculate actual pitches of audio frames in the audio segment s1. If the YIN algorithm calculates that the audio frame 1 has an actual pitch, then the audio frame 1 is regarded as an audio frame having a pitch. If the YIN algorithm calculates that the audio frame 2 has no actual pitch, then the audio frame 2 is regarded as an audio frame having no pitch. The present disclosure may perform pitch detection on all audio frames in the audio segment s1 according to the above method, and the number of audio frames having pitches is the total number of pitches. In addition, if the threshold exceedance count S of Formula 8 is larger than one-half of the total number of pitches, then the target audio segment s1 is determined to be a plurality of sound-source audio segment, representing that multiple people are speaking in the target audio segment s1.

Referring to step 280 in FIG. 2, if the threshold exceedance count is zero, the target audio segment is a single sound-source audio segment. For example, referring to FIG. 1 and FIG. 4, if the threshold exceedance count S of Formula 8 is zero, then the target audio segment s1 is determined to be a single sound-source audio segment, representing that only one person is speaking in the target audio segment s1. As described above, the audio detection device 100 and the audio detection method 200 of the present disclosure may receive audio through the sound receiver 110, and calculate audio to determine a number of users on site. Therefore, the audio detection device 100 and the audio detection method 200 of the present disclosure may avoid the problem that an image tracking technology has blind spots and thus cannot effectively monitor a user, and have advantages of low computation and easy implementation.

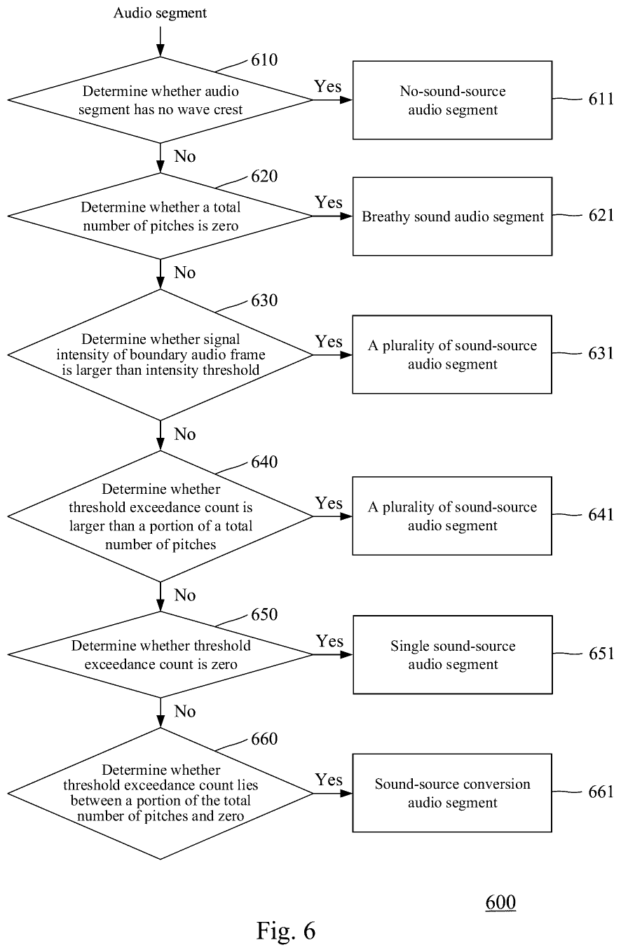

FIG. 6 shows an embodiment of a flow diagram of an audio detection method 600 of the present disclosure. The present disclosure may determine all audio segments s1~s9 in FIG. 4 according to the audio detection method 600, so as to determine which type each of the audio segments s1~s9 respectively belongs to, thereby understanding how many speakers each of the audio segments s1~s9 includes.

Referring to step 610 in FIG. 6, the audio detection method 600 of the present disclosure may determine whether the audio segment has no wave crest. If the audio segment s1 indeed does not include any wave crest, the audio segment s1 is determined as a no-sound-source audio segment in step 611, in other words, there is no speaker in the audio segment s1. In addition, if the audio segment s1 includes a wave crest, step 620 is performed.

Referring to step 620 in FIG. 6, the audio detection method 600 of the present disclosure may determine whether a total number of pitches is zero. If the total number of pitches is zero, the audio segment s1 is determined as a breathy sound audio segment in step 621, in other words, only a breathy sound exists in the audio segment s1. In addition, if the total number of pitches of the audio segment s1 is not zero, step 630 is performed.

Referring to step 630 in FIG. 6, the audio detection method 600 of the present disclosure may determine whether a signal intensity of a boundary audio frame is larger than an intensity threshold. If the range of the audio segment s1 is between a first audio frame and a twenty-third audio frame, the first audio frame and the twenty-third audio frame are both boundary audio frames of the audio segment s1. The audio detection method 600 of the present disclosure may set the intensity threshold to −3 dB. If the signal intensity of the first audio frame is larger than −3 dB, or the signal intensity of the twenty-third audio frame is larger than −3 dB, the audio segment s1 is determined as a plurality of sound-source audio segment in step 631, in other words, there are multiple speakers in the audio segment s1. In addition, if the signal intensities of the first audio frame and the twenty-third audio frame are both not larger than −3 dB, step 640 is performed.

Referring to step 640 in FIG. 6, the audio detection method 600 of the present disclosure may determine whether a threshold exceedance count is larger than a portion of a total number of pitches. For example, if a threshold exceedance count S of Formula 8 is larger than one-half of the total number of pitches, then the audio segment s1 is determined to be a plurality of sound-source audio segment in step 641, in other words, a plurality of speakers are present in the audio segment s1. In addition, if the threshold exceedance count S of Formula 8 is not larger than one-half of the total number of pitches, step 650 is performed.

Referring to step 650 in FIG. 6, the audio detection method 600 of the present disclosure may determine whether the threshold exceedance count is zero. For example, if the threshold exceedance count S of Formula 8 is zero, then the audio segment s1 is determined to be a single sound-source audio segment in step 651, in other words, only one speaker is present in the audio segment s1. In addition, if the threshold exceedance count S of Formula 8 is not zero, step 660 is performed.

Referring to step 660 in FIG. 6, the audio detection method 600 of the present disclosure may determine whether the threshold exceedance count lies between a portion of the total number of pitches and zero. For example, if the threshold exceedance count S of Formula 8 lies between one-half of the total number of pitches and zero, then the audio segment s1 is determined to be a sound-source conversion audio segment in step 661, in other words, a speaker in the audio segment s1 is converting from a speaker A to a speaker B.

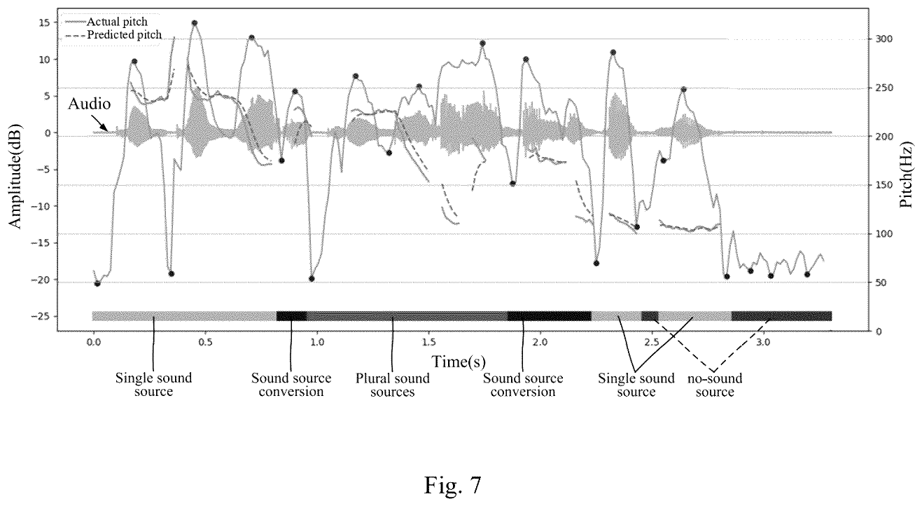

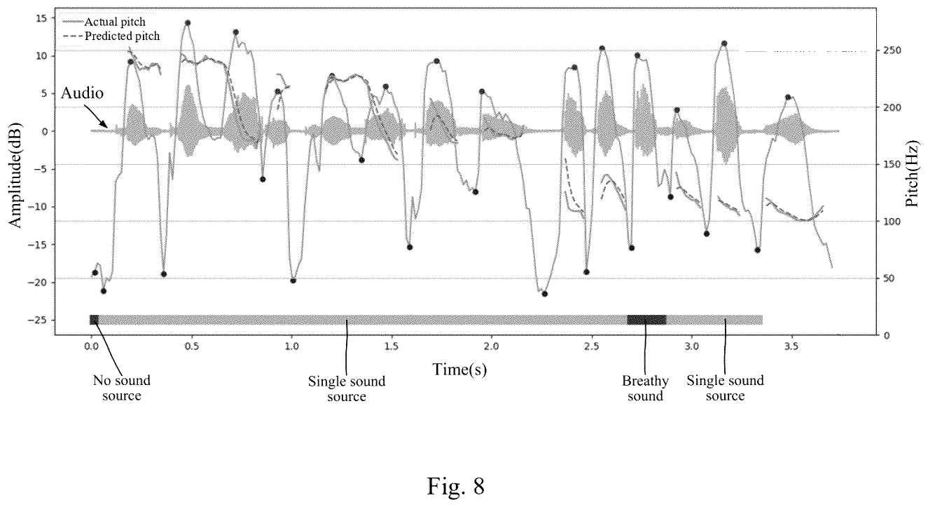

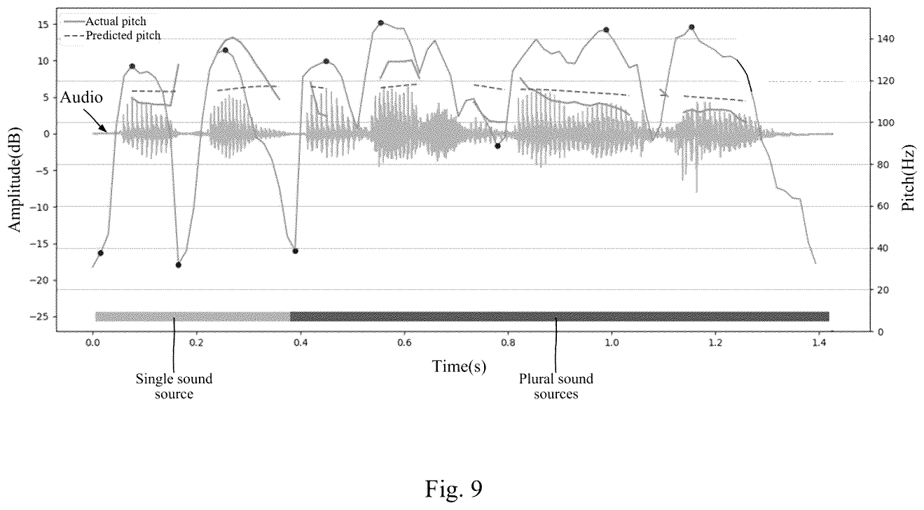

FIGS. 7 to 9 show embodiments of audio and pitch of the present disclosure. As shown in FIGS. 7 to 9, after detecting the audio according to the audio detection method 600 of the present disclosure, a number of speakers in different regions may be obtained, and the above regions may include a plurality of audio segments. For example, in a single sound-source region, an actual pitch (solid line) and a predicted pitch (dashed line) are close to each other, representing that a single sound-source (e.g., only one person speaking) is present. In a plurality of sound-source region, the actual pitch (solid line) and the predicted pitch (dashed line) deviate from each other, representing that the current state is not a single sound-source and thus leads to inaccurate prediction, and a plurality of sound-sources (e.g., a plurality of persons speaking) are present. In addition, if a state lies between a single sound-source and a plurality of sound-sources, then it represents a sound-source conversion region, in other words, a speaker in this region is converting from a speaker A to a speaker B. Furthermore, if no wave crest exists in a region, then it is a no-sound-source region, in other words, no sound-source (e.g., no one speaking) exists in the region. In addition, in a breathy sound region, a total number of pitches is zero, representing that only a breathy sound exists.

It should be noted that the present disclosure is not limited to the embodiments as shown in FIG. 1 to FIG. 9, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

Technical features of some embodiments of the present disclosure make an improvement to the prior art. The audio detection method and the audio detection device of the present disclosure may be applied to various electronic systems, and the number of users can be obtained by collecting audio through the electronic system and performing calculation on the audio, not only avoiding the problem that using the image-tracking technologies has blind spots and cannot effectively monitor users, but also having advantages of low computational load and ease of implementation.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An audio detection method, executed by a processor reading at least one command stored in a memory, comprising:
performing a framing process on audio to generate a plurality of audio frames;
dividing the audio into a plurality of audio segments according to a plurality of signal intensities of the plurality of audio frames;
calculating a plurality of actual pitches of the plurality of audio frames of a target audio segment of the plurality of audio segments;
calculating a plurality of predicted pitches according to the plurality of actual pitches of the target audio segment;
calculating a plurality of pitch differences according to the plurality of actual pitches of the target audio segment and the plurality of predicted pitches;
calculating a threshold exceedance count according to the plurality of pitch differences of the target audio segment and a pitch threshold;
if the threshold exceedance count is larger than a portion of a total number of pitches of the plurality of actual pitches of the target audio segment, determining that the target audio segment is a plurality of sound-source audio segment; and
if the threshold exceedance count is zero, determining that the target audio segment is a single sound-source audio segment.

2. The audio detection method of claim 1, further comprising:
if the threshold exceedance count is between one-half of the total number of pitches of the target audio segment and zero, determining that the target audio segment is a sound-source conversion audio segment.

3. The audio detection method of claim 1, wherein dividing the audio into the plurality of audio segments according to the plurality of signal intensities of the plurality of audio frames comprises:
calculating the plurality of signal intensities of the plurality of audio frames;
obtaining a plurality of wave crests and a plurality of wave troughs according to the plurality of signal intensities; and
dividing the audio into the plurality of audio segments according to the plurality of wave troughs.

4. The audio detection method of claim 1, further comprising:
if the target audio segment does not comprise any wave crest, determining that the target audio segment is a no-sound-source audio segment; and
if the total number of pitches of the plurality of actual pitches of the target audio segment is zero, determining that the target audio segment is a breathy-sound audio segment.

5. The audio detection method of claim 1, further comprising:
if a first signal intensity of a first boundary audio frame of the target audio segment is larger than an intensity threshold, or a second signal intensity of a second boundary audio frame of the target audio segment is larger than the intensity threshold, determining that the target audio segment is the plurality of sound-source audio segment.

6. An audio detection device, comprising:
a memory, configured to store at least one command;
a processor, configured to read the at least one command in the memory to execute:
performing a framing process on audio to generate a plurality of audio frames;
dividing the audio into a plurality of audio segments according to a plurality of signal intensities of the plurality of audio frames;
calculating a plurality of actual pitches of the plurality of audio frames of a target audio segment of the plurality of audio segments;
calculating a plurality of predicted pitches according to the plurality of actual pitches of the target audio segment;
calculating a plurality of pitch differences according to the plurality of actual pitches of the target audio segment and the plurality of predicted pitches;
calculating a threshold exceedance count according to the plurality of pitch differences of the target audio segment and a pitch threshold;
if the threshold exceedance count is larger than a portion of a total number of pitches of the plurality of actual pitches of the target audio segment, determining that the target audio segment is a plurality of sound-source audio segment; and
if the threshold exceedance count is zero, determining that the target audio segment is a single sound-source audio segment.

7. The audio detection device of claim 6, wherein the processor further reads the at least one command in the memory to execute:
if the threshold exceedance count is between one-half of the total number of pitches of the target audio segment and zero, determining that the target audio segment is a sound-source conversion audio segment.

8. The audio detection device of claim 6, wherein the processor further reads the at least one command in the memory to execute:
calculating the plurality of signal intensities of the plurality of audio frames;
obtaining a plurality of wave crests and a plurality of wave troughs according to the plurality of signal intensities; and
dividing the audio into the plurality of audio segments according to the plurality of wave troughs.

9. The audio detection device of claim 6, wherein the processor further reads the at least one command in the memory to execute:
if the target audio segment does not comprise any wave crest, determining that the target audio segment is a no-sound-source audio segment; and
if the total number of pitches of the plurality of actual pitches of the target audio segment is zero, determining that the target audio segment is a breathy-sound audio segment.

10. The audio detection device of claim 6, wherein the processor further reads the at least one command in the memory to execute:
if a first signal intensity of a first boundary audio frame of the target audio segment is larger than an intensity threshold, or a second signal intensity of a second boundary audio frame of the target audio segment is larger than the intensity threshold, determining that the target audio segment is the plurality of sound-source audio segment.
